(19) United States
(12) Patent Application Publication
(10) Pub. No.: US 2014/0043095 A1
(43) Pub. Date: Feb. 13, 2014

(54) VOLTAGE-STABILIZING CIRCUIT

(71) Applicant: HAI-QING ZHOU, Shenzhen City (CN)

(72) Inventor: HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/597,282

(22) Filed: Aug. 29, 2012

(30) Foreign Application Priority Data
Aug. 13, 2012 (CN) 2012102860751

(51) Int. Cl. G05F 3/08

(52) U.S. Cl. 327/538

(57) ABSTRACT

A voltage-stabilizing circuit for stabilizing an output voltage of a power integrated circuit (IC) includes an electronic switch and an RC circuit. The RC circuit includes a resistor and a capacitor. A first terminal of the resistor receives an enable signal and is connected to a control terminal of the electronic switch. A second terminal of the resistor is grounded through the capacitor, and is further connected to an enable pin of the power IC. A first terminal of the electronic switch is connected to a node between the resistor and the capacitor. A second terminal of the electronic switch is grounded.

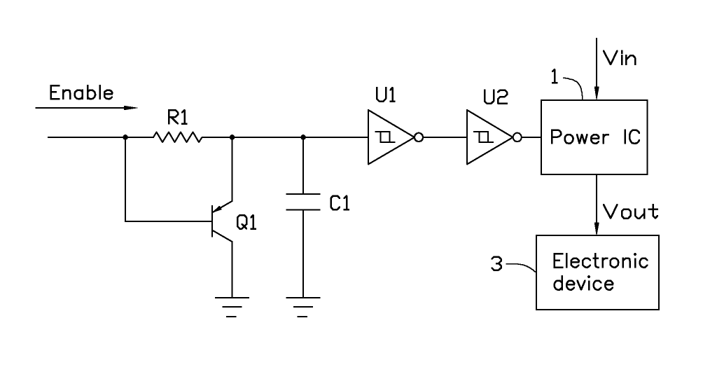

### BACKGROUND

1. Technical Field

The present disclosure relates to a circuit for stabilizing voltage.

2. Description of Related Art

When a voltage received by the enable pin of a power integrated circuit (IC) is greater than a threshold voltage, the power IC outputs a voltage. If the voltage received by the enable pin is not stable, problems with the power IC may occur. Therefore, there is room for improvement in the art.

### BRIEF DESCRIPTION OF THE DRAWING

Many aspects of the embodiments can be better understood with reference to the following drawings. The components in the drawing are not necessarily drawn to scale, the emphasis instead being placed upon clearly illustrating the principles of the present embodiments. Moreover, in the drawing, like reference numerals designate corresponding parts throughout the view.

The FIGURE is a circuit diagram of an exemplary embodiment of a voltage-stabilizing circuit.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references mean at least one.

Referring to the FIGURE, an exemplary embodiment of a voltage-stabilizing circuit for stabilizing an output voltage of a power integrated circuit (IC) 1, includes a resistor R1, a capacitor C1, a pnp-type bipolar junction transistor (BJT) Q1, and two Schmitt triggers U1 and U2. The voltage-stabilizing circuit is connected to an enable pin of the power IC 1 for making a power received at an input pin Vin of the power IC 1 be transmitted to an electronic device 3 through an output pin Vout of the power IC 1.

A first terminal of the resistor R1 receives an enable signal Enable. A second terminal of the resistor R1 is grounded through the capacitor C1. The first terminal of the resistor R1 is further connected to a base of the BJT Q1. A collector of the BJT Q1 is grounded. An emitter of the BJT Q1 is connected to a node between the resistor R1 and the capacitor C1. The node between the resistor R1 and the capacitor C1 is further connected to an input pin of the trigger U1. An output pin of the trigger U1 is connected to an input pin of the trigger U2. An output pin of the trigger U2 is connected to the enable pin of the power IC 1. In the embodiment, the resistor R1 and the capacitor C1 makes up an RC circuit.

During the process of the electronic device 3 and the power IC 1 being powered on, the voltage of the enable signal Enable is unstable. The enable signal Enable charges the RC circuit and is not input to the trigger U1. In detail, when the enable signal Enable is at a high level, the enable signal Enable charges the capacitor C1 through the resistor R1. The input pin of the trigger U1 does not receive the high level signal. When the enable signal Enable is at a low level, the BJT Q1 is turned on, such that the capacitor C1 is discharged through the BJT Q1. The input pin of the trigger U1 does not receive the high level signal.

After a delay time, when the enable signal Enable becomes stable, and the capacitor C1 is fully charged, the input pin of the trigger U1 receives a high level signal. The triggers U1 and U2 process the high level signal and then transmit the high level signal to the enable pin of the power IC 1, such that the power IC 1 outputs the power to the electronic device 3.

During the process of the electronic device 3 and the power IC 1 being powered off, the enable signal Enable is still in an active state. When the enable signal Enable is at a high level, the enable signal Enable charges the capacitor C1 through the resistor R1. The input pin of the trigger U1 does not receive the high level signal. When the enable signal Enable is at a low level, the BJT Q1 is turned on, such that the capacitor C1 is discharged through the BJT Q1. The input pin of the trigger U1 does not receive the high level signal.

After a time delay, when the enable signal Enable is stopped, the input pin of the trigger U1 does not receive the high level signal. As a result, the power IC 1 is deactivated.

In the embodiment, the pnp-type BJT Q1 functions as an electronic switch. Furthermore, the triggers U1 and U2 are used to smooth the enable signal Enable. In other embodiments, the triggers U1 and U2 can be omitted.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A voltage-stabilizing circuit for stabilizing an output voltage of a power integrated circuit (IC), comprising:
an electronic switch; and
an RC circuit comprising a resistor and a capacitor, wherein a first terminal of the resistor receives an enable signal, the first terminal of the resistor is further connected to a control terminal of the electronic switch, a second terminal of the resistor is grounded through the capacitor, the second terminal of the resistor is further connected to an enable pin of the power IC; a first terminal of the electronic switch is connected to a node between the resistor and the capacitor, a second terminal of the electronic switch is grounded;
wherein when the control terminal of the electronic switch receives a low level signal, the first terminal is connected to the second terminal of the electronic switch; when the control terminal receives a high level signal, the first terminal is disconnected from the second terminal of the electronic switch.

2. The circuit of claim 1, further comprising first and second triggers connected between the second terminal of the resistor and the enable pin of the power IC, wherein an input pin of the first trigger is connected to the second terminal of the resistor, an output pin of the first trigger is connected to an input pin of the second trigger, an output pin of the second trigger is connected to the enable pin of the Power IC.

3. The circuit of claim 1, wherein the electronic switch is a pnp-type bipolar junction transistor (BJT), the control terminal of the electronic switch is a base of the BJT, the first terminal of the electronic switch is an emitter of the BJT, and the second terminal of the electronic switch is a collector of the BJT.
